(19) United States
(12) Patent Application Publication
(10) Pub. No.: US 2012/0074261 A1
(43) Pub. Date: Mar. 29, 2012

(54) FUSELAGE ARRANGEMENT, AIRCRAFT OR SPACECRAFT AND METHOD

(76) Inventors: Wolf-Dietrich Dolzinski, Ganderkesee (DE); Michael Kolax, Hamburg (DE)

(21) Appl. No.: 13/240,174

(22) Filed: Sep. 22, 2011

Related U.S. Application Data
(60) Provisional application No. 61/386,233, filed on Sep. 24, 2010.

(30) Foreign Application Priority Data
Sep. 24, 2010 (DE) 10 2010 041 335.6

(51) Int. Cl. B64C 1/00; B64D 45/00; B23P 11/00; B64C 1/18

(52) U.S. Cl. 244/121; 244/119; 29/428

(57) ABSTRACT

The present invention provides a fuselage arrangement for an aircraft or spacecraft, comprising: a skin portion which consists substantially of fibre composite material and/or of a fibre-composite/metal mixed material; a metal floor structure which is mounted on the skin portion; and a plurality of electrical system components which are interconnected in an electrically conductive manner by means of the floor structure.

### CROSS-REFERENCE TO RELATED APPLICATIONS

This application claims the benefit of and priority to U.S. Provisional Application No. 61/386,233, filed Sep. 24, 2010 and German Patent Application No. 10 2010 041 335.6, filed Sep. 24, 2010, the entire disclosures of which are herein incorporated by reference.

### FIELD OF THE INVENTION

The present invention relates to a fuselage arrangement, an aircraft or spacecraft and a method.

Although applicable to any aircraft or spacecraft, the present invention and the problem on which it is based will be explained in detail with reference to an aircraft.

In the past, fuselage shells were made of metal, in particular aluminium. Electrical system components, for example engines or generators, could, for potential equalisation between them, easily be connected in an electrically conductive manner by one of their terminals to a respective fuselage shell. However, fuselage shells of this type are increasingly being made from a fibre composite material, for example carbon fibre reinforced plastics materials (CFRP), or a fibre-composite/metal mixed material, for example aluminium/glass-fibre laminate (GLARE). Furthermore, it is known from DE 10 2005 045 181 A1 to produce even parts of floors from CFRP.

This has the effect that additional electrical lines are required in the aircraft in order to provide the mentioned potential equalisation between the electrical system components. However, this is disadvantageously associated with expense in terms of weight and cost.

### SUMMARY OF THE INVENTION

An object of the present invention is to at least reduce the above-described drawbacks.

A fuselage arrangement for an aircraft or spacecraft is accordingly provided, comprising a skin portion which consists substantially of fibre composite material and/or of a fibre-composite/metal mixed material, a metal floor structure which is mounted on the skin portion, and a plurality of electrical system components which are interconnected in an electrically conductive manner by means of the floor structure.

Furthermore, an aircraft or spacecraft comprising the fuselage arrangement according to the invention is provided.

A method, in particular in the aviation or aerospace industry, is also provided, comprising the following steps: equipping a floor structure with system components and installing the equipped floor structure in a skin portion for an aircraft or spacecraft.

The idea underlying the present invention consists in assigning a double function to the floor structure. First the floor structure carries loads, in particular the chairs and people arranged on the floor structure. Furthermore, because the floor structure is made of metal, it can provide an electrically conductive connection between electrical system components for potential equalisation between them.

Advantageous configurations of the present invention emerge from the dependent claims.

In the present case, “consists substantially of fibre composite material and/or of a fibre-composite/metal mixed material” means that the skin portion otherwise comprises basically no other materials, in particular no metallic materials.

According to a preferred configuration of the fuselage arrangement according to the invention, at least one transverse and/or longitudinal support of the floor structure is made of metal. This also includes the case that the transverse and/or longitudinal supports consist exclusively of metal. The floor structure can also comprise panels, for example made of sandwich material, which are held between the transverse and longitudinal supports.

According to a further preferred configuration of the fuselage arrangement according to the invention, the floor structure is formed in such a way that it provides electrical shielding for at least one of the plurality of electrical system components, in particular for an electrical line. Thus, for example, a special electrically shielding sleeve for the electrical line can be dispensed with.

According to a further preferred configuration of the fuselage arrangement according to the invention, a plurality of system components are combined to form a module. The modular construction accelerates the process of equipping the floor structure with system components, since by means of the modular approach a plurality of system components (in the form of a module) can be mounted mechanically on the floor structure in one step and can optionally all simultaneously be connected in an electrically conductive manner in the same step or a further step.

According to a further preferred configuration of the fuselage arrangement according to the invention, substantially all the electrical lines which extend in the longitudinal and/or transverse direction of the fuselage arrangement extend within the floor structure. If, for example, two electrical system components which are each arranged on the base of the skin portion (i.e. substantially at the lowest point of the bottom of the fuselage arrangement), need to be interconnected in an electrically conductive manner for potential equalisation, this can easily be achieved by means of electrical lines which lead substantially in the vertical direction of the fuselage arrangement from the respective electrical system components to the floor structure. The horizontal connection between the electrical system components then occurs either by means of a line which, viewed in cross-section, extends within the thickness of the floor structure and can thus be held very easily on the floor structure or by means of the electrically conductive floor structure itself.

According to a further preferred configuration of the fuselage arrangement according to the invention, the system components, viewed in cross-section, are arranged within the thickness of the floor structure. As a result, all the system components can easily be held on the floor structure.

According to a further preferred configuration of the fuselage arrangement according to the invention, the floor structure comprises at least two similar interfaces to which a first or a second system component can be connected electrically and/or mechanically in each case. As a result, the first or second system component can be attached to the first or second interface as required, depending on which system component is required. Furthermore, the first or second system component can be flexible in terms of location because it is possible to attach it to the first or to the second interface. This results in a simpler assembly process overall.

According to a preferred configuration of the method according to the invention, before the equipping step a plurality of system components are combined to form a module and during the equipping step the module formed is connected to the floor structure.

### BRIEF DESCRIPTION OF THE DRAWINGS

The invention will be described below in more detail by way of embodiments with reference to the accompanying figures of the drawings, in which:

FIG. 1 is a sectional view through a fuselage arrangement according to an embodiment of the present invention; and

FIG. 2 is a side view A from FIG. 1, a skin portion of the fuselage arrangement—apart from the outer limit of the skin portion—being shown as though transparent.

### DESCRIPTION OF EXEMPLARY EMBODIMENTS

In the figures, like reference numerals denote like or functionally equivalent components, unless stated otherwise.

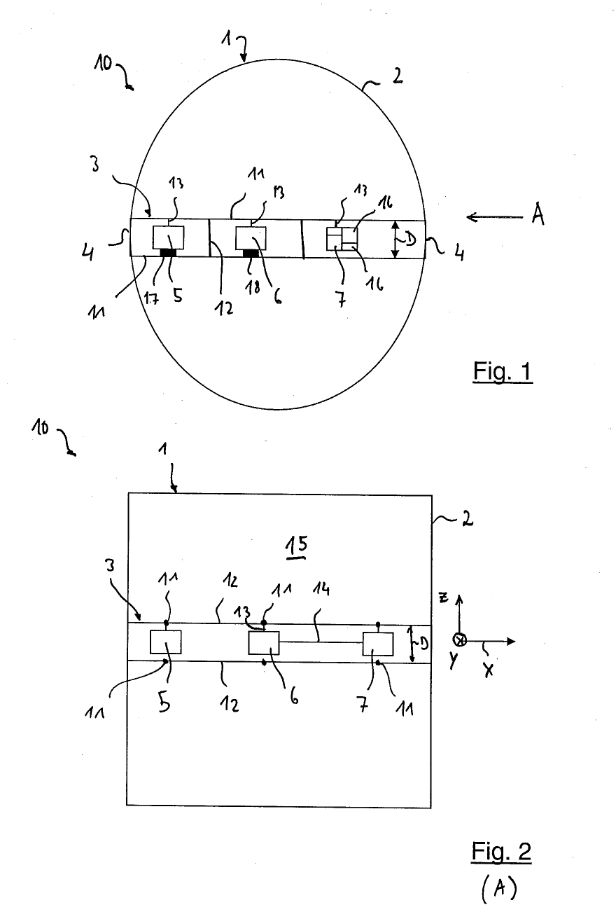

FIG. 1 is a sectional view of a fuselage arrangement 1 according to an embodiment of the present invention, and FIG. 2 is a side view A from FIG. 2.

The fuselage arrangement 1 is part of an aircraft or spacecraft 10 (not shown in greater detail).

The fuselage arrangement 1 comprises a skin portion 2 which is substantially oval in shape. The skin portion 2 can be made up of a plurality of individual shells. The skin portion 2 consists exclusively of fibre composite material, for example CFRP, and/or of a fibre-composite/metal mixed material, for example GLARE.

The fuselage arrangement 1 further comprises a floor structure 3 made of metal, in particular aluminium. The floor structure 3 is rigidly mounted at its respective ends 4 on the skin portion 2.

The fuselage arrangement 1 further comprises electrical system components 5, 6, 16. These are interconnected in an electrically conductive manner for potential equalisation between them by means of the floor structure 3. This can take place for example by means of metallic transverse and longitudinal supports 11 and 12 of the floor structure 3 and by means of terminals 13. The terminals 13 connect a respective system component 5, 6, 16 to one of the transverse supports 11.

Furthermore, the longitudinal supports 12 of the floor structure 3 are for example provided in such a way that they shield an electrical line 14 extending within the floor structure 3 (see FIG. 2) electrically from the environment which is denoted as a whole by reference numeral 15.

It can further be seen from FIG. 2 that the system components 16 are combined to form a module 7. As a result, the system components 16 can be installed in the floor structure 3 much more quickly.

FIG. 2 also shows that all the electrical lines 14 (only one is shown in the Fig.) which extend in the longitudinal direction X of the fuselage arrangement 1 (incidentally preferably also those which extend in the transverse direction Y of the fuselage arrangement 1, although this is not shown), extend within the floor structure 3. This means that otherwise basically no lines extend in the longitudinal direction X or the transverse direction Y within the fuselage arrangement 1.

It can also be seen from FIGS. 1 and 2 that the system components 5, 6 and 16 are arranged within the thickness D of the floor structure 3. In the present case, “thickness” means the spatial extent of the floor structure 3 in the vertical direction Z.

The floor structure 3 further comprises at least two similar interfaces 17, 18. The system component 5 is fixed mechanically to the interface 17. However, the system component 6 could equally well be fixed to the interface 17. The system component 6 is fixed mechanically to the interface 18. However, the system component 5 could equally well be fixed mechanically to the interface 18.

The method for producing the fuselage arrangement 1 of FIGS. 1 and 2 will be explained briefly below.

In a first method step, the module 7 is assembled from the plurality of system components 16. The floor structure 3 is then equipped with the system components 5, 6 and the module 7. The equipping process can include connecting the system components 5, 6 mechanically to the interfaces 17 and 18 and providing the electrical terminals 13. The floor structure 3 including the system components 5, 6 and the module 7 is then installed in the skin portion 2 as a unit.

Although the present invention has been described herein with reference to preferred embodiments, it is not limited thereto but can be modified in a variety of ways. In particular, the above-described configurations and embodiments of the fuselage arrangement according to the invention can be applied accordingly to the aircraft or spacecraft according to the invention and to the method according to the invention, and vice versa. It should also be noted that herein “a/an” does not exclude a plurality.

### LIST OF REFERENCE NUMERALS

1 fuselage arrangement
2 skin portion
3 floor portion
4 end
5 system component
6 system component
7 module
10 aircraft
11 transverse support
12 longitudinal support
13 terminal
14 line
15 environment
16 system component
17 interface
18 interface
D thickness
X spatial direction
Y spatial direction
Z spatial direction

1. A fuselage arrangement for an aircraft or spacecraft, comprising: a skin portion which consists substantially of fibre composite material and/or of a fibre-composite/metal mixed material; a metal floor structure which is mounted on the skin portion; and a plurality of electrical system components which are interconnected in an electrically conductive manner by means of the floor structure.

2. The fuselage arrangement according to claim 1, wherein at least a transverse and/or longitudinal support of the floor structure is made of metal.

3. The fuselage arrangement according to claim 1, wherein the floor structure is formed in such a way that it provides electrical shielding for at least one of the plurality of electrical system components, in particular for an electrical line.

4. The fuselage arrangement according to claim 1, wherein a plurality of system components are combined to form a module.

5. The fuselage arrangement according to claim 1, wherein the system components, viewed in cross-section, are arranged within the thickness of the floor structure.

6. The fuselage arrangement according to claim 1, wherein substantially all the electrical lines which extend in the longitudinal and/or transverse direction of the fuselage arrangement extend within the floor structure.

7. The fuselage arrangement according to claim 1, wherein the floor structure comprises at least two similar interfaces to which a first or a second system component can be connected electrically and/or mechanically in each case.

8. An aircraft or spacecraft, comprising a fuselage arrangement according to claim 1.

9. A method, in particular in the aviation or aerospace industry, comprising the following steps: equipping a floor structure with system components; and installing the equipped floor structure in a skin portion for an aircraft or spacecraft.

10. The method according to claim 9, wherein before the equipping step a plurality of system components are combined to form a module and during the equipping step the module formed is connected to the floor structure.
